(19) United States
(12) Patent Application Publication
(10) Pub. No.: US 2007/0239496 A1
(43) Pub. Date: Oct. 11, 2007

(54) Method, system and computer program for operational-risk modeling

(75) Inventors: Chonawee Supatgiat, Gattikon (CH); Christopher M. Kenyon, Dubling (IE); Lucas S. Heusler, Zurich (CH)

Correspondence Address: GEORGE A. WILLINGHAN, III;AUGUST LAW GROUP, LLC, P.O. BOX 19080, BALTIMORE, MD, 21284-9080, US

(73) Assignee: International Business Machines Corporation, Armomk, NY (US)

(21) Appl. No.: 11/338,025

(22) Filed: Jan. 24, 2006

(30) Foreign Application Priority Data
Dec. 23, 2005 (EP) 05112970.8

(51) Int. Cl. G06F 17/50

(52) U.S. Cl. 705/7

(57) ABSTRACT

The invention relates to a method for modelling the operational risk of an entity, the method comprising the steps of: Compiling a list with one or more failure events; Compiling a list with one or more causes of the failure events; Compiling a list with one or more impact types of the failure events; Evaluating interdependencies between the failure events, the causes of the failure events and the impact types of the failure events; Decomposing the interdependencies, thereby establishing one or more independent impact sub-models.

### TECHNICAL FIELD

The invention relates to a method, a system and a computer program for operational risk modelling.

### BACKGROUND OF THE INVENTION

Operational-risk management and quantification has recently become more important owing to the new Basel II regulations. Basel II is the common notation for §644 of the International Convergence of Capital Measurement and Capital Standards. These regulations require capital allocation for operational risk, complementing the existing requirements on market and credit risk. Operational risk is, e.g., the risk of loss resulting from inadequate or failed internal processes, people, systems or from external events.

There are several types of methods known to assist in operational risk management. One type of known methods is based on the observation of losses and their magnitudes to quantify operational risk. High level approaches mitigate operational risks by insurance.

It is an object of the invention to provide improved solutions for operational risk modeling.

### SUMMARY AND ADVANTAGES OF THE INVENTION

The present invention is directed to a method, a system and a computer program as defined in independent claims. Further embodiments of the invention are provided in the appended dependent claims.

According to a first aspect of the present invention there is provided a method for modeling the operational risk of an entity, the method comprising the steps of:

Compiling a list with one or more failure events of the entity;

Compiling a list with one or more causes of the failure events;

Compiling a list with one or more impact types of the failure events;

Evaluating interdependencies between the failure events, the causes of the failure events and the impact types of the failure events;

Decomposing the interdependencies, thereby establishing one or more independent impact sub-models.

The method according to this aspect of the invention introduces a way to handle and solve large and complex operational risk quantification problems. This is established by means of decomposing the complex large-scale problem of operational risk into smaller independent impact sub-models. An impact sub-model comprises the modeling of failure events that have the same or a similar impact on the entity. The entity can be in particular a business entity. This decomposition approach maintains the failure and impact dependencies, thus facilitating the aggregation of the results.

As taking dependencies into account increases the size and complexity of the model, the method facilitates the user to model failure dependencies and impact dependencies.

The method according to this aspect of the invention has the advantage that it preserves the cause-to-effect relationship that reveals how operational risk can be reduced, managed, and controlled. The method allows to capture the causes of operational failures and their resulting effects in terms of losses. This quantification includes explicit modeling of the linkage between cause and effect.

Such a cause-to-effect operational-risk modeling method allows to manage operational risks of an entity, e.g. a business entity, beyond simple quantification. If a financial institution wants to change the capital allocation required under Basel II for operational risk it is advantageous to understand the causes, in particular the root causes, of operational risk and how they lead to loss events. Beyond this overall management of operational risk, cause-to-effect modeling also enables the inclusion of operational risk in the business decision processes, such as business process re-engineering, infrastructure re-engineering and infrastructure operation.

The method is dynamic in that it allows to capture failure dependencies and impact dependencies.

According to a preferred embodiment of this aspect of the invention the evaluation is performed by means of setting up an interdependency graph between the failure events, the causes of the failure events and the impact types of the failure events. Then the independent impact sub-models are established by means of decomposing the interdependency graph.

This preferred embodiment is a very structured approach. It allows to find effective solutions even for very complex business models. The identification of disconnected sub-graphs can be done preferably by using standard graph-theory methods.

According to a further preferred embodiment of this aspect of the invention the impact sub-models comprise one or more failure sub-models that correspond to failure events which share the same causes.

By means of decomposing the impact sub-models further into failure sub-models the modeling of the operational risk is further simplified. As the failures which have the same causes can be correlated, the failure sub-models allow the modeling of the correlated failure event arrivals. Preferably each failure sub-model is solved separately.

According to a further preferred embodiment of the invention each of the impact sub-models comprises an impact-calculation sub-model that calculates from failure event arrivals the corresponding financial impacts for the entity.

The failure event arrivals are preferably provided in form of a stochastic process, i.e. in form of a random function of time. The impact calculation sub-models receive the failure event arrivals from the failure sub-models and calculate the resulting financial impact as output.

According to a further preferred embodiment of the invention the impact sub-models are solved by means of statistical analysis.

This is in particular applicable for rather simple operational risk modeling tasks.

According to a further preferred embodiment of the invention the impact sub-models are solved by means of simulation.

Such a solution based on simulation is broadly applicable.

According to a further preferred embodiment of the invention the outputs of the impact sub-models are combined to obtain the impact distribution of the entity.

The combination of the outputs of the impact sub-models results in an impact distribution of the whole entity. This allows the evaluation of the overall operational risk of the entity.

According to a further preferred embodiment of the invention the impact distribution of the entity is derived from the impact sub-models by means of convolution.

As due to the decomposition the impact sub-models are independent of each other, the impact distributions of the impact sub-models can be aggregated by convolution. This can generally be done numerically or, in case of standard impact distributions, analytically. The impact distribution is preferably represented in terms of losses.

According to a second aspect of the present invention there is provided a system comprising means for carrying out the steps of the method according to anyone of claims 1 to 10.

According to a third aspect of the present invention there is provided a computer program comprising instructions for carrying out the steps of the method according to anyone of claims 1 to 10 when this computer program is executed on a computer system.

### DESCRIPTION OF THE DRAWINGS

Preferred embodiments of the invention are described in detail below, by way of example only, with reference to the following schematic drawings.

FIG. 1 shows the operational risk taxonomy of failure events;

FIG. 2 illustrates schematically the decomposition of an operational risk model by means of impact-sub-models;

FIG. 3 illustrates a method for operational risk quantification that preserves the cause to effect relationships;

FIG. 4 shows an interdependency graph between failure events, causes of the failure events and the impact types of the failure events;

FIG. 5 illustrates the business process of a clearing house;

FIG. 6 shows the Information Technology (IT) infrastructure map of a service provider offering settlement services for the clearing house of FIG. 5;

FIG. 7 shows an interdependency graph between the failure events, the causes of the failure events and the impact types of the failure events of the business process of the service provider;

FIG. 8 shows the decomposition of the interdependency graph of FIG. 7;

FIG. 9 shows a decomposed operational risk model with independent impact sub-models of the service provider;

FIG. 10 shows the loss distribution for a first impact sub-model;

FIG. 11 shows the loss distribution for a second impact sub-model;

FIG. 12 shows the loss distribution for a third impact sub-model;

FIG. 13 shows the aggregate loss distribution from the first, the second and the third impact sub-model in case of a non-redundant IT-infrastructure of the service provider;

FIG. 14 shows a comparison of the aggregate loss distribution of a non-redundant IT-infrastructure with a redundant IT-infrastructure, each for the service provider;

FIG. 15 shows the expected loss over the server replacement intervals for the service provider;

FIG. 16 shows a schematic representation of a computer system that is suitable for performing the methods described with reference to FIG. 1 to 15.

The drawings are provided for illustrative purpose only and do not necessarily represent practical examples of the present invention to scale. The same or similar elements of the drawings are denoted with the same reference signs.

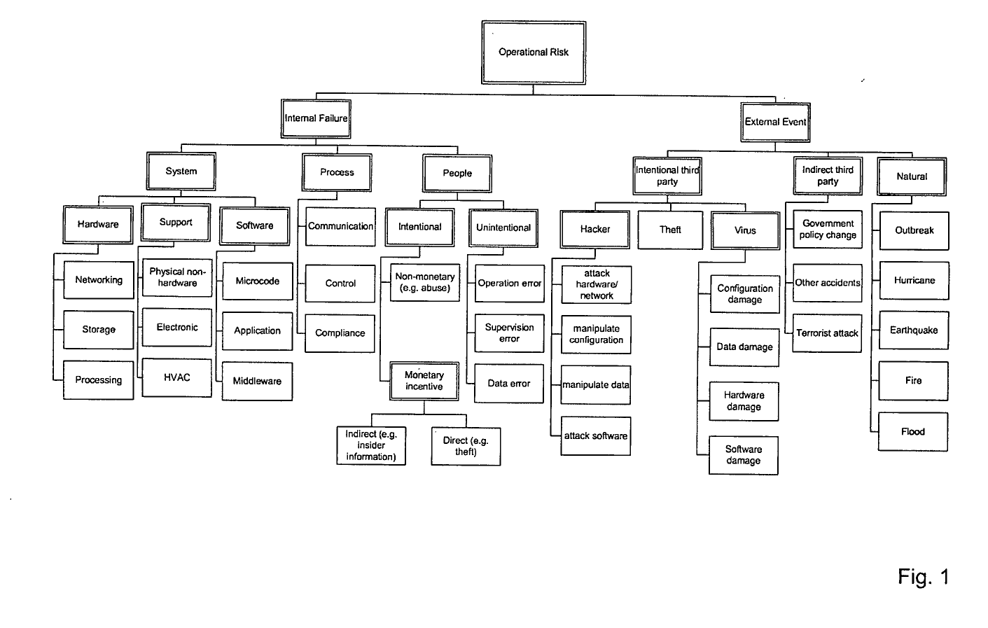

FIG. 1 shows an operational-risk failure-event taxonomy, which is based on the classification of operational risk event types according to Basel II. There are more than 30 types of operational-risk loss events, and each type of event also has several subtypes.

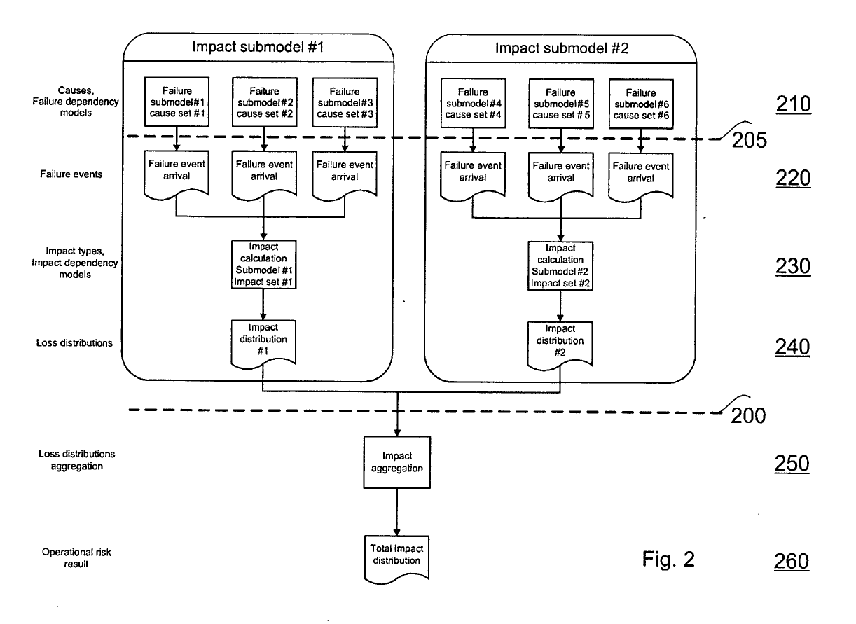

FIG. 2 illustrates a method of operational-risk modeling according to a preferred embodiment of the invention. The decomposition is done in two layers. In a layer 200 the failure-event type occurrences from the Operational-Risk Failure-event Taxonomy as shown in FIG. 1 are categorized by impact dependencies. The failure events that cause the same impact are grouped into an impact sub-model. In the embodiment illustrated in FIG. 1 two impact sub-models #1 and #2 are shown. For example, if a contract violation penalty is calculated as the sum of the numbers of a first failure event and a second failure event, both failure events should be in the same impact sub-model. As another example, people stealing a trade secret of a company would not cause a day-to-day business disruption impact. Hence such theft events can be categorized into a different impact sub-model than types of failure events that entail a business disruption impact.

The impact sub-models #1 and #2 are decomposed further in a layer 205. Within each impact sub-model #1 and #2, failure-events are categorized by their causes of failures. The failure events that have the same causes are grouped together in failure sub-models. For each failure sub-model the system is modeled in such a way that it generates correct failure event arrivals for each type of failure event. Because the failure events from the same cause can be correlated, having them in the same model allows to correctly model the correlated failure event arrivals.

In the exemplary embodiment of FIG. 2 the impact sub-model #1 comprises a failure sub-model #1, based on a cause set #1, a failure sub-model #2, based on a cause set #2 and a failure sub-model #3, based on a cause set #3. In addition, the impact sub-model #1 comprises an impact calculation sub-model #1, based on an impact set #1. The impact sub-model #2 comprises a failure sub-model #4, based on a cause set#4, a failure sub-model #5, based on a cause set #5, a failure sub-model #6, based on a cause set #6 and an impact calculation sub-model #2, based on an impact set #2.

The sub-models in each layer can be dealt with separately. In the following the steps lo for modelling the operational risk according to this exemplary embodiment of the invention are explained. In a step 210 each failure sub-model #1 to #6 is solved separately. As a result, in step 220 failure event arrivals are provided, preferably in form of a stochastic process, i.e. in form of a random function of time. In step 230 the failure event arrivals of the failure sub-models #1 to #6 are translated into financial impacts by means of the impact calculation sub-models #1 and #2. As a result, in step 240 the financial impact of the impact sub-model #1 is provided as impact distribution #1 and the financial impact of the impact sub-model #2 is provided as impact distribution #2. The impact distributions are preferably provided in form of probability distributions of the financial impact, in particular losses, over a predefined period of time. In other words, the impact calculation sub-models #1 and #2 use the failure event arrivals as input and calculate the resulting financial impact as output. Since all failure events that have the same impact type are in the same impact sub-model, the resulting impact distribution can be correctly calculated. Moreover, the resulting impact distributions from different impact sub-models are independent because they do not share causes. Hence, these impact distributions can be appropriately aggregated in step 250 by means of convolution. As a result, the total impact distribution of the overall system or business entity is provided in step 260. The convolution can be done numerically or analytically.

Usually the impact calculation and failure sub-models will be solved by means of simulation. In this case, the majority of the computation time for modeling is spent on solving the impact calculation sub-models and the failure sub-models rather than on the convolution. One of the benefits of the decomposition technique is to reduce the number of simulation replications. Suppose there are m sub-models and each requires n replications, with this decomposition the number of required replications is n*m, whereas without this decomposition the number of required replications is n^{m}.

In the following the cause-to-effect operational-risk quantification methodology based on the above described layering and decomposition concept is described in more detail.

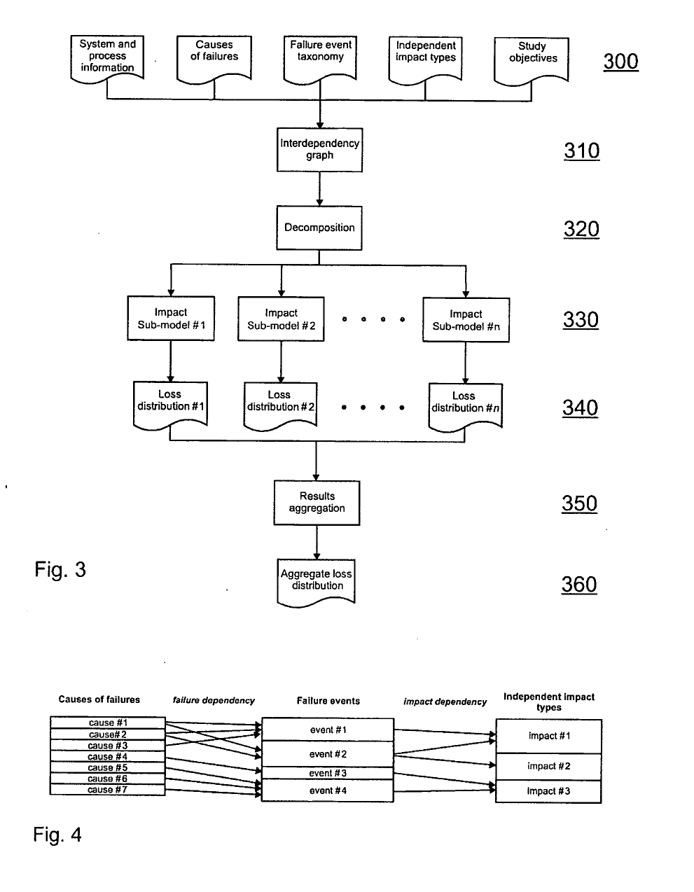

FIG. 3 illustrates in form of a flow chart an exemplary embodiment of a method for modeling the operational risk of a business entity. In a step 300 the study objectives of operational risk modeling are identified and the related system and business process information is obtained. The system and business process information describes e.g. the business processes, the people and the IT systems of interest. This information can be obtained from questionnaires and interviews as well as from process and IT architecture documents. The study objectives define the appropriate level of detail for the modeling.

Study objectives may be business process (BP) driven, information technology (IT) driven, or loss driven. Typical examples of objectives driven by these different interests are
BP-driven objectives
   What is the effect (in operational-risk terms) of adding a new insurance lo product to an existing people/systems infrastructure?
   How can the operational risk of this BP be reduced by 50 percent?
IT-driven objectives
   What is the effect (in operational-risk terms) of consolidating these servers into one mainframe?
   How can we reduce the operational risk of our database access by 50 percent?
Loss-driven objectives
   What are the three most important root causes of loss for this line of business and what would it cost to reduce them by 50 percent?
   Should we have a mirror system for BP X?

The identified study objectives drive the level of detail for model development, data collection, and monitoring. Based on the identified study objectives, a list of possible failure events, causes of the failure events and impact types of the failure events is compiled. The failure event taxonomy of FIG. 1 may be used in this step. Then in step 310 the interdependencies between the failure events, the causes of the failure events and the impact types of the failure events are evaluated by means of setting up an interdependency graph.

Such an interdependency graph is show in FIG. 4. It has three columns, namely a column comprising a list with causes of failure events, a column comprising a list with failure-events and a column comprising a list with independent impact types of the failure events. This interdependency graph links causes of failures with failure events and their impact (loss distributions). An arrow from cause R to failure event E denotes ‘R can cause E’, and an arrow from failure event E to impact type T signifies ‘E can have impact type T’.

The taxonomy as shown in FIG. 1 provides a general list of failure or operational-risk events that can be used as a starting point for compiling a list of relevant risk events (failure events) for a specific case. The impact of these risk (failure) events is identified and failure and impact dependencies are determined. For example, in determining a failure dependency, the relationship between the failure rate and the age of the failure component or the state of the system should be understood. In determining an impact dependency, the relationship between the impact and the system state or the failure duration should be understood. For example, it is common that in a continuous impact, such as a business disruption, the impact increases, possibly exponentially, with the failure duration.

Base information to create the interdependency graph can be provided in many forms.

Table 1, an event-dependency chart, is one such example that can be used to assist in identifying failure and impact dependencies. Typically, such an event-dependency chart is derived from operations surveys, actual experience, and interviews.

TABLE 1
An example of an event-dependency chart

| | | failure arrival rate | | | Impact | |
|---|---|---|---|---|---|---|
| Sub-class | Events | f(age) | f(state) | Effect | f(duration) | Remark |
| Internal | hardware | high for new, | high if high | backup system | yes | high if the backup |
| Hardware | failure | low for non- | volume or bad | failover, | | also breakdown. |
| failure | | new, high | maintenance | replacement/ | | Otherwise, low |
| | | again for | | repair of the | | |
| | | very old | | failed hardware | | |
| | backup | high for new, | high if high | cannot retrieve | yes | depend on the loss |
| | data | low for non- | volume or bad | history, recover- | | data and recovering |
| | storage | new, high | maintenance | ing cost, replace/ | | time |
| | failure | again for | | repair cost | | |
| | | very old | | | | |
| | communi- | high for new, | high if high | unable to communi- | yes | depend on whether |
| | cation | low for non- | volume or bad | cate with customers, | | there is a critical |
| | network | new, high | maintenance | replace/repair cost | | information to convey |
| | failure | again for | | | | |
| | | very old | | | | |

In a following step 320, standard graph-theory methods are used to identify disconnected (independent) sub-graphs in the interdependency graph. For example, the graph in FIG. 4 contains two sub-graphs in the impact layer, i.e. the (1, 2, 3; 1, 2; 1, 2) sub-graph and the (4, 5, 6, 7; 3, 4; 3) sub-graph, where (x; y; z) denotes a sub-graph containing causes x, failure events y, and impact types z. These two disconnected sub-graphs represent two separate impact sub-models. As a result, the failure-events that have the same impact are grouped together into one impact sub-model. These impact sub-models are shown in the layer 200 of the decomposition map in FIG. 2.

Within the second sub-graph, there are two sub-graphs in the failure layer, i.e. the (4; 3) sub-graph and the (5, 6, 7; 4) sub-graph, where (x; y) denoted a sub-graph containing causes x and failure events y. These two disconnected sub-graphs represent two separate failure sub-models within their same impact sub-model. As a result, the failure-events that share the same causes are grouped together into one failure sub-model. These failure sub-models are shown in the layer 205 of the decomposition map in FIG. 2.

Referring back to FIG. 3, in a following step 330 each impact sub-model #1 to #n is solved separately to obtain its output. For the failure sub-models of the impact sub-models, correlated failure-event arrivals in form of a stochastic process are generated. The common techniques to solve these failure sub-models are statistical analysis and/or simulation. The failure event arrivals of the failure sub-models are then translated into impact distributions by means of the impact calculation sub-models. The impact distribution is represented in terms of monetary value, i.e. as loss distribution. In a step 340 these loss distributions #1 to #n are received from the impact sub-models #1 to #n. Depending on the complexity of the impact dependencies, the loss distribution might be deduced directly from the failure event arrivals by means of an analytical approach. According to another embodiment of the invention this can be done by means of simulation.

For each sub-model, the system is preferably modeled at the highest possible detail level in order to avoid unnecessary work. For example, for the failure event “power-failure” all components that share the same power line can be grouped into one single object in the model because they all will fail in a power outage. On the other hand, for the failure event “hardware-failure” each component should be treated as a separate object in the model because its failure pattern may heavily depend on its different characteristics such as its states and its age.

Referring again to FIG. 3, in a following step 350 the impact (loss) distributions #1 to #n resulting from the impact sub-models #1 to #n are combined to obtain the total loss/impact distribution of the modeled system. Due to the decomposition, the resulting loss distributions #1 to #n from the impact sub-models are independent of each other because they do not share the same cause of failure and their failure events do not affect the impact of the other impact sub-models #1 to #n. Therefore, the impact distributions from the impact sub-models #1 to #n can be correctly aggregated by convoluting them numerically. If all impact distributions are standard, it is possible to convolve them analytically. As a result, in step 360 the aggregate loss distribution is provided.

In the following, an example for modeling the operational risk of a service provider that offers settlement services to a clearing house is described in detail.

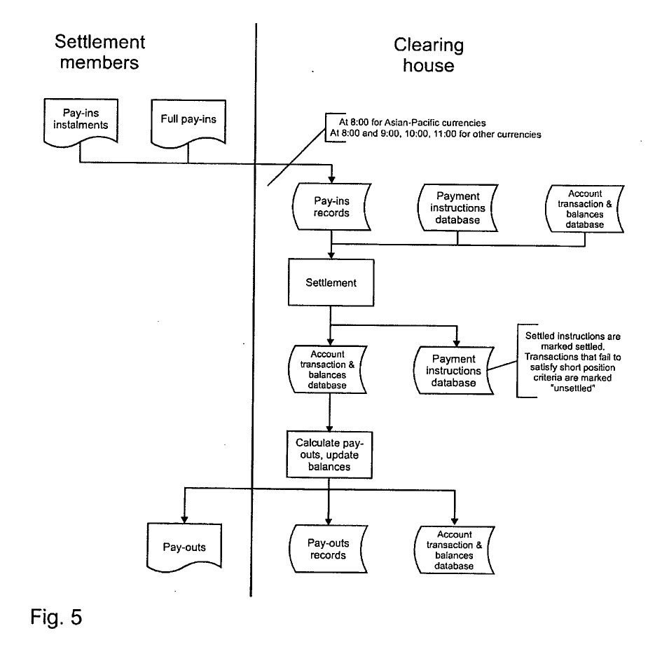

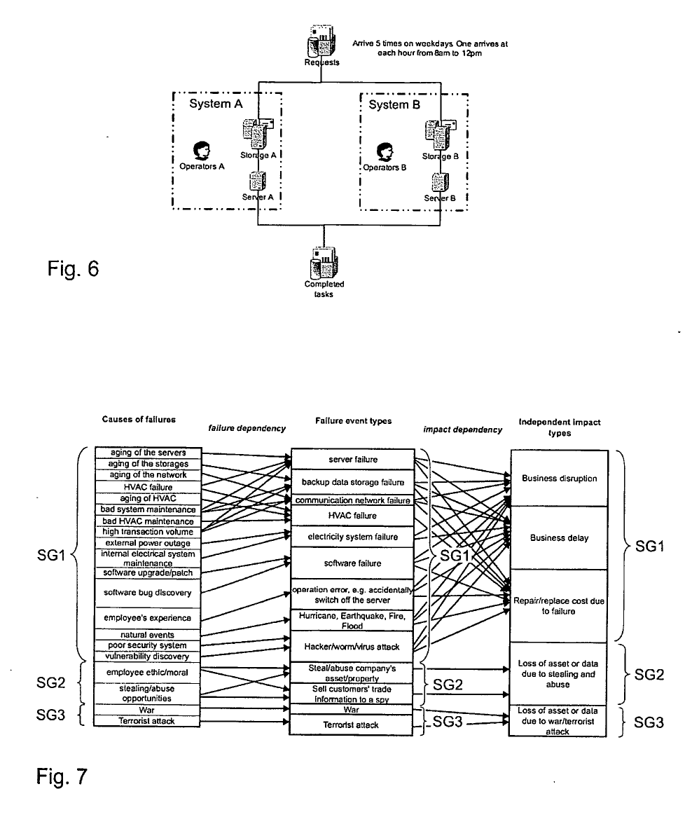

FIG. 5 illustrates the settlement process of the clearing house. The clearing house receives pay-in installments and full pay-ins, processes them and provides pay-outs. FIG. 6 shows the Information Technology (IT) infrastructure map of the service provider that provides the complete settlement service for the clearing house.

The example illustrates that the described modeling of operational risks may assist in making business decisions impacting the operational risk. Specifically, it is examined a system-architectural question, namely, the value of having a redundant system, and an operational question, namely, the optimal frequency for server replacement.

All simulations are run for a five-year period using a discrete event simulation system (Arena™). Arena is a software and trademark of Rockwell Automation Inc. Numerical results are given for the entire period. Other simulation software tools can be used as well.

The IT infrastructure of the service provider, as illustrated in FIG. 6, consists of (potentially) two redundant systems, namely a first system A and a second system B. The system A comprises a storage A and a server A. The system B comprises a storage B and a server B.

For this example it is assumed that the practitioner wants to resolve two business problems. The first is an architectural problem, i.e. whether to have a redundant system, and the second is an operational problem, i.e. when to replace aging servers. The level of detail needed in the model must be sufficient to capture the effects of these decisions.

For this example, there are several types of impact. The most important one is a penalty charge from the violation of the service level agreement (SLA). The charge is calculated based on the performance and the breakdown time. The impact function is defined in a form of service credit (or service-level violation penalty).

Each month, the service provider will be charged $500,000 if any one of the following events occurs:
The aggregate breakdown time is more than two hours per calendar month.
There is a single breakdown of more than one-hour duration.
There is more than one breakdown of 30-minute duration or longer each month in the rolling three-month period.

Each month, the service provider will also be charged $100,000 if any one of the following events occurs:
The settlement completion is delayed by 30 minutes in any given day.
It is delayed by ten minutes or more for two or more business days.
The total delay time exceeds 90 minutes in that month.

Other impacts besides SLA violation penalties are: maintenance cost; disaster or other recovery cost; loss due to stealing of company assets or confidential information; and potential reputation loss, which includes the future sales loss.

The taxonomy in FIG. 1 may assist in producing a list of potential operational-risk events (failure events) related to this example. In the event-dependency chart in Table 2, this list is shown in the column labeled ‘Event’. The column f(age) explains the relationship between the failure rate and the age of the failing component (when all other state variables are fixed). The column f(state) of the failure arrival rate indicates the state of the world that influences the failure arrival rate. Similarly, the column Remark of the impact indicates the influence of the system state on the size of the impact. The column f(duration) indicates whether the impact size depends on the failure duration. Usually in a continuous impact, such as a business disruption, the impact increases—possibly exponentially—with the failure duration.

TABLE 2
Possible operational-risk events related to the service provider in form of an event dependency chart
Possible Operational Risk Events

| Internal/ | Main- | | | failure arrival rate | | |
|---|---|---|---|---|---|---|
| External | class | Sub-class | Events | f(age) | f(state) | Effect |
| Internal | System | Internal | hardware failure | high for new, low for non- | high if high volume or bad | backup system failover, |
| | | Hardware | | new, high again for very old | maintenance | replacement/repair of the |
| | | failure | | | | failed hardware |
| | | | backup data storage | high for new, low for non- | high if high volume or bad | cannot retrieve history, |
| | | | failure | new, high again for very old | maintenance | recovering cost, |
| | | | | | | replace/repair cost |
| | | | communication | high for new, low for non- | high if high volume or bad | unable to communicate |
| | | | network failure | new, high again for very old | maintenance | with customers, |
| | | | | | | replace/repair cost |
| | | Supporting | HVAC failure | high for new, low for non- | high if bad maintenance | can lead to hardware |
| | | system failure | | new, high again for very old | | failure, replace/repair |
| | | | | | | cost |
| | | | internal electricity | constant over time | high if bad maintenance or a | backup system failover |
| | | | system failure | | new change in electricity | |
| | | | | | system | |
| | | Software | main settlement | high for new version or new | high if there is a change in | backup system failover if |
| | | failure | software failure | patch, low for old | the system | detected |
| | | | non-core software | high for new version or new | high if there is a change in | non-core software |
| | | | failure | patch, low for old | the system | mulfunction |
| | People | Intentional | Stealing | higher for a new hire, | may depend on opportunities | monetary loss |
| | failure | | | decreasing over time | | |
| | | | Sell customers' trade | high for a new hire, | may depend on opportunities | reputational risk, leading |
| | | | information to a spy | decreasing over time | | to bankruptcy. |
| | | Unintentional | operation error, e.g. | high for a new hire, | same for every state | vary from no impact to |
| | | | acidentally switch off | decreasing over time | | business disruption |
| | | | the server | | | |
| | | | uninformed absent of | independent of years of | may be higher during a flu | no one operates the |
| | | | an operator | service | season! | system |
| External | Third | Intentional | Hacker/worm/virus | Increasing over time if no | high when there is a new | vary from no impact to |
| | party | | attack | action is done to fix the | discovery of new volnerability | business disruption |
| | | | | volnerability | | |
| | | Indirect | War | independent | higher if there is a tension | vary from no impact to |
| | | | | | with other countries. | business disruption or |
| | | | | | | total loss |
| | | | Terrorist attack | independent | higher if there is an evidence | vary from no impact to |
| | | | | | that it is a possible target for | total loss |
| | | | | | terrorists | |
| | Natural | | Hurricane, | independent | high if there is a | vary from no impact to |
| | | | Earthquake, Fire, | | weather/geology incident | total loss |
| | | | Flood | | forecast | |

Impact

| Internal/ | Main- | | | f(dura- | |
|---|---|---|---|---|---|
| External | class | Sub-class | Events | tion) | Remark |
| Internal | System | Internal | hardware failure | yes | high if the backup also breakdown. Otherwise, low |
| | | Hardware | | | |
| | | failure | | | |
| | | | backup data storage | yes | depend on the loss data and recovering time |
| | | | failure | | |
| | | | communication | yes | depend on whether there is a critical information |
| | | | network failure | | to convey |
| | | Supporting | HVAC failure | yes | depend on when it occurs, weekend or rush hours |
| | | system failure | internal electricity | yes | high if the backup also breakdown. Otherwise, low |
| | | | system failure | | |
| | | Software | main settlement | yes | high if not detect or the backup system is also |
| | | failure | software failure | | breakdown. Otherwise, low |
| | | | non-core software | yes | depending on how critical of the failed application |
| | | | failure | | |
| | People | Intentional | Stealing | no | mild (use company phone for private calls), high |
| | failure | | | | (steal company property) |
| | | | Sell customers' trade | no | depend on the information |
| | | | information to a spy | | |
| | | Unintentional | operation error, e.g. | yes | depending on the error |
| | | | acidentally switch off | | |
| | | | the server | | |
| | | | uninformed absent of | yes | high if the system require an attention |
| | | | an operator | | |
| External | Third | Intentional | Hacker/worm/virus | yes | high if not detect or the backup system is also |
| | party | | attack | | infected. Otherwise, low |
| | | Indirect | War | yes | depending on the situation |
| | | | Terrorist attack | yes | depending on the attack |
| | Natural | | Hurricane, | yes | high if no warning or the backup system is also |
| | | | Earthquake, Fire, | | affected. Otherwise, low |
| | | | Flood | | |

All the failure events in the event-dependency chart (the ‘Event’ column in Table 2) are put into the middle section of the interdependency graph (the middle section of FIG. 7). Based on the ‘failure arrival rate’ column in the event-dependency chart (Table 2), we can identify the causes of the failure events and list them in the interdependency graph as shown in FIG. 7 (the left-hand section of FIG. 7). Next we identify the impact types from the information in the ‘Effect’ and ‘Impact’ columns of the event-dependency chart and put them into the right-hand section of the interdependency graph of FIG. 7.

As a result, a list of failure events, causes of the failure events and impact types of the failure events is provided.

In order to evaluate the interdependencies between the failure events, the causes of the failure events and the impact types of the failure events, all three sections of the interdependency graph of FIG. 7 are linked by arrows to indicate the dependencies. The information from the ‘failure arrival rate’ column of the event-dependency chart of Table 2 is used to create the failure dependency arrows, and the information from the ‘impact’ column is used to create the impact dependency arrows.

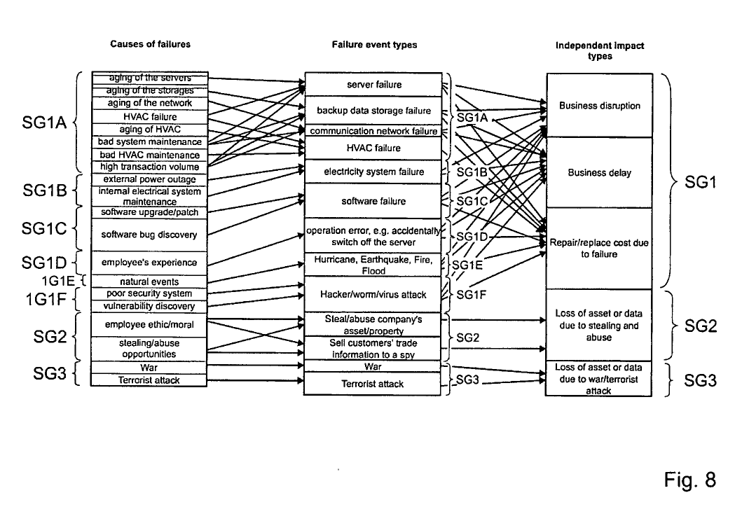

Identifying the disconnected sub-graphs, the interdependency graph of FIG. 7 is decomposed into three sub-graphs SG1, SG2 and SG3. Furthermore, the first sub-graph SG1 can be further decomposed into smaller disconnected sub-graphs SG1A, SG1B, SG1C, SG1D, SG1E and SG1F. The disconnected sub-graphs in this layer are shown in FIG. 8.

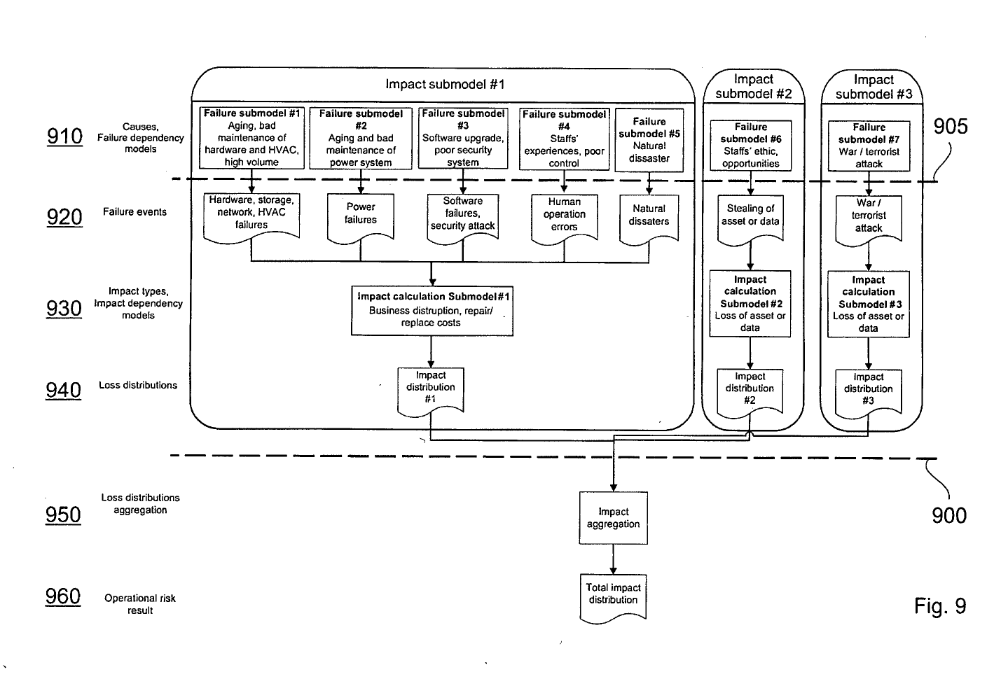

As a result, the interdependencies have been decomposed and independent impact and failure sub-models have been identified. The decomposition map for this example is shown in FIG. 9.

A layer 900 in this decomposition map consists of three impact sub-models (impact sub-model #1, impact sub-model #2 and impact sub-model #3). In this layer 900, all failure-events (failure event types) that affect the same impact type are grouped together. The impact sub-model #1 comprises the failure events hardware failures, storage failures, network failures, heating, ventilating and air conditioning (HVAC) failures, power failures, software failures, failures due to human operation errors and failures due to natural disasters. All these failure events can cause a business disruption, repair/replace costs and/or SLA violation. Therefore, they have been arranged in the same impact sub-model #1. The second impact type is the loss of assets or confidential data, such as the legal costs and asset replacement cost incurred. It is assumed that operating assets cannot be stolen, whereas maintenance assets and spare parts can be. This type of failure event does not entail a business disruption, and hence can be assigned to another impact sub-model #2. The same holds true in the case of the failure event war or terrorist attack, where the loss due to business disruption is protected by a force majeure clause in the SLA contract. The only impact of this event type is the costs of repairs and replacements. Hence this is established as impact sub-model #3.

The impact sub-model #1 comprises in a further layer 905 five failure sub-models, namely failure sub-model #1, failure sub-model #2, failure sub-model #3, failure sub-model #4 and failure sub-model #5. The impact sub-model #2 comprises in the layer 905 a failure sub-model #6 and the impact sub-model #3 comprises in the layer 905 a failure sub-model #7.

Note that in this example it is assumed that a bad maintenance policy can according to failure sub-model #1 cause hardware, storage, network and HVAC failures and according to failure sub-model #2 cause power failures. Further it is assumed, e.g., that human errors, such as accidentally switching off a server, have a direct effect in terms of business disruption, but no significant effects in terms of the hardware, HVAC and power failure rates. If this assumption shall be relaxed and human errors shall be allowed to affect hardware, HVAC, and power failure rates, then the failure sub-models #1, #2, and #4 must be combined into a single failure sub-model. In both cases, all the failure sub-models can be practically implemented using a simulation approach.

For each impact and failure sub-model, the parameters to monitor are identified based on the causes of failures and the failure and impact dependencies identified in Table 2. The sub-models should contain detail levels such that those parameters can be monitored. The failure and impact parameters and variables in the model are listed in the non-shaded columns of Table 3. The shaded columns are from the event-dependency chart constructed earlier.

TABLE 3
Failure and impact variables

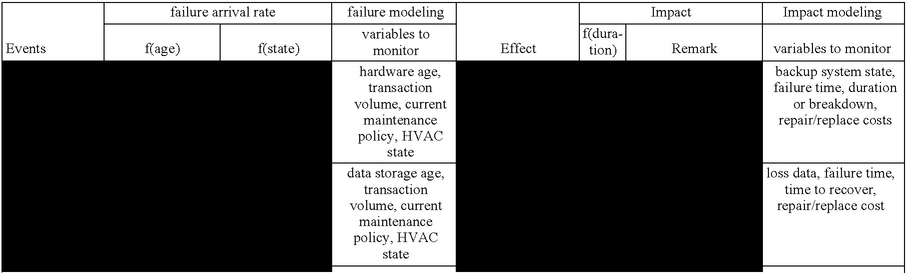

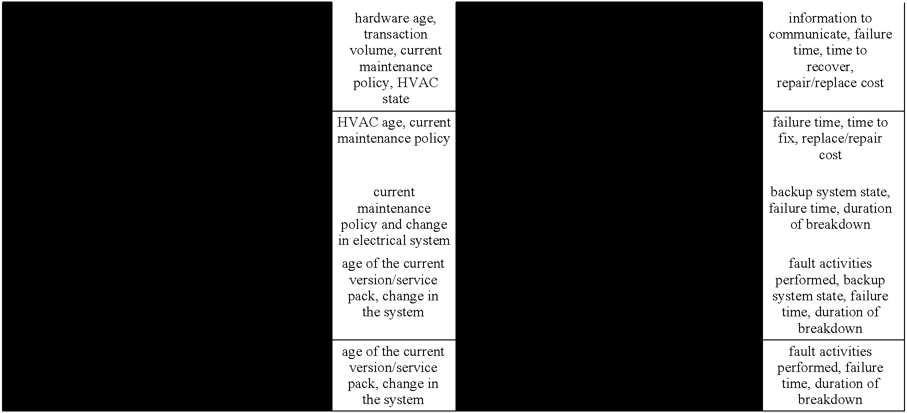

The failure and impact variables to monitor are the key to determine the level of details for each sub-model. Each sub-model should be at such a level of detail that these variables can be monitored. In each impact-calculation sub-model, the failures are transformed into impacts. The impact variables to monitor are necessary for impact calculation. For example, we can calculate the level of SLA violation due to a hardware failure if we know the state of the backup system, the failure time and duration, and the repair/replace cost. It is also possible that one type of failure can impact another type of failure. For example, a HVAC failure for an extended period of time can increase the failure arrival rate of some hardware components. Such correlated events can be captured by a simulation model, which is explained in the following.

There are several different ways to estimate the failure or impact functions and their parameters. The most acceptable way is to perform statistical analysis of the historical data. If no historical data exists, the operational staff who defines the dependencies listed in Table 1, should be able to provide information on the functions or their parameters. In the worst case, i.e. if there is no idea about a particular input assumption, a sensitivity analysis of that assumption must be performed.

Because in this example the input assumption modeling technique for each particular sub-model is not the goal, some dummy numbers are assumed for these functions and parameters. For illustration purpose only, we now describe some of our input assumptions for this example.

Referring to Impact sub-model #1 in FIG. 9, it is shown an example of cause-to-effect modeling in detail.

The most important features included in Impact sub-model #1 are listed below. First the impact calculation sub-model#1 is described, i.e. how the failure events (the stochastic process of the failure events) are translated into losses by means of the impact calculation sub-model #1 of the impact sub-model #1. Then the failure sub-models #1 to #5 that generate the failure events (the stochastic process of the failure events) are described.

Impact calculation sub-model #1

Impact (business disruption, business delay, repair/replacement costs)
Business disruptions and delays incur penalties as defined by the SLA; these are important (costly) during business hours and not important (i.e. no penalty) outside business hours.
Repair or replacement cost is stochastic and incurred depending on the hardware (including HVAC) failure severity.

Failure sub-model #1
Hardware aging-repair-replace: The hardware failure rate increases as the hardware gets older. For example, the mean number of days between server failures is equal to 1200 divided by the server age in months. The age of the hardware is reset to zero when it is replaced by new hardware.
Facilities aging-repair-replace: The HVAC failure rate depends on its age.
Utilization: Utilization of hardware can increase its failure rate; for example, the age of a storage disk increases by one month when it handles extremely high traffic or high volume. In each settlement round, the traffic can have an extremely high volume with a probability of 0.005.
Knock-on effect of failures: If HVAC fails for an extended period, the hardware will be affected. For example, the hardware age increases by one month if the HVAC fails for more than one day.
Queuing: The processing delay depends on the transaction volume as described by the queuing incurred. The delay increases when the volume increases (because of increased queuing).
Redundancy: A failure in one system triggers a fail-over to another redundant system; if the redundant system is operational then there will be no business disruption impact.

Failure sub-model #2
Power outage: The arrival and duration of outages are random. The uninterruptible power supply (UPS) provides backup power for a maximum of one day.

Failure sub-model #3
Correlated upgrades: The model allows some of software upgrades to affect both systems at the same time. For example, 80 percent of software upgrades will affect both servers, whereas 20 percent of the upgrades will affect only one server.
Software upgrades: The failure rate of the software increases significantly when it is upgraded. Software failure includes all failure root causes, including security violations.
Software maintenance: The software failure rate decreases when the software gets older. For example, the mean time between software failures is equal to 2*(age in months)².
Software security: The effect of attacks on software is modeled by software failures and included in the software upgrades and maintenance items above.

Failure sub-model #4
Human error and experience: The operator error arrival rate is higher for a new-hire system operator. The possibility that a human error will affect both systems simultaneously can be different from the effects of software failure.

Failure sub-model #5
Natural disasters: Random arrival and severity.

Such level of detail can be handled by simulation. Arena™ software was used to model and run the simulation.

In the following the steps for modeling the operational risk of the service provider are explained with reference to FIG. 9. In a step 910 each failure sub-model #1 to #7 is solved separately. As a result, in step 920 failure event arrivals are provided, preferably in form of a stochastic process, i.e. in form of a random function of time. In step 930 the failure event arrivals of the failure sub-models #1 to #5 are translated into financial impacts by means of the impact calculation sub-model #1, the failure event arrivals of the failure sub-model #6 are translated into a financial impact by means of the impact calculation sub-model #2 and the failure event arrivals of the failure sub-model #7 ate translated into a financial impact by means of the impact calculation sub-model #3. As a result, in step 940 the financial impact of the impact sub-model #1 is provided as impact distribution #1, the financial impact of the impact sub-model #2 is provided as impact distribution #2 and the financial impact of the impact sub-model #3 is provided as impact distribution #3. The impact distributions #1 to #3 are preferably provided in form of probability distributions of the financial impact, in particular losses, over a predefined period of time. These impact distributions #1 to #3 can be appropriately aggregated in step 950 by means of convolution. As a result, the total impact distribution in terms of losses of the operational risk of the service provider is derived in step 960.

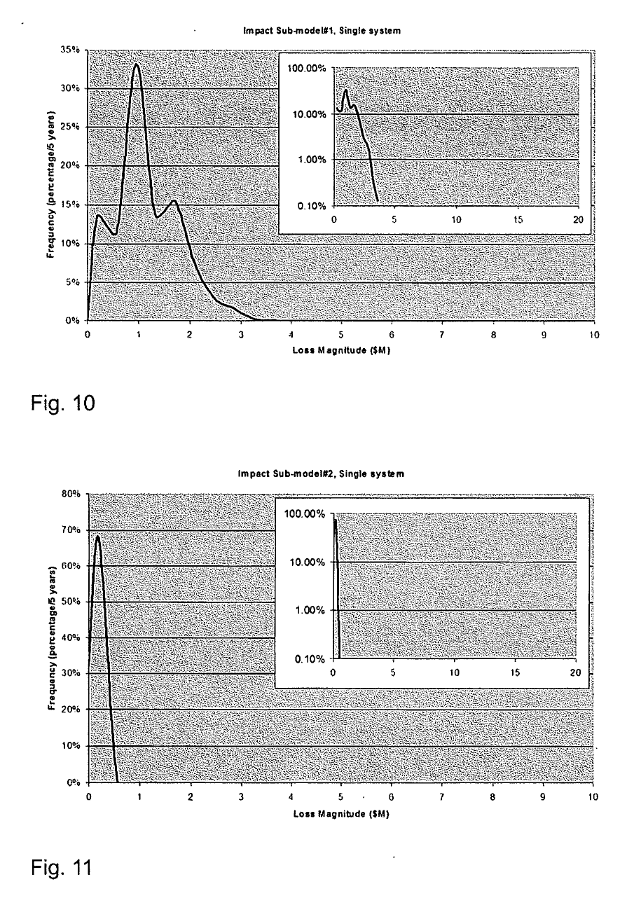

In the following, example outputs of the impact sub-models are shown. In this particular example, 10,000 replications were simulated. The graph in FIG. 10 is an output of Impact sub-model #1, i.e. the model for business disruption, delay, and repair/replace cost due to failure.

Table 4 shows the statistical results. The logarithmic graph (inset) of FIG. 10 illustrates that there are no tail events of interest.

Table 4 shows a statistical description of the loss distributions for business disruption with and without a redundant system. For ease of comparison, the results for the redundant system are shown before the explicit consideration of redundancy in the text. Clearly the presence of a redundant system has a huge beneficial impact on business disruption/delay.

TABLE 4

| | single | double |
|---|---|---|
| mean | 1,144,811 | 397,922 |
| s.d. | 640,416 | 169,660 |
| 99% VaR | 2,908,608 | 842,165 |
| 95% VaR | 2,283,496 | 689,555 |
| min | 40 | 326 |
| max | 3,744,896 | 1,563,095 |

VaR means value at risk, which is a number indicating the operational risks in terms of losses for the considered time period, which is 5 years in this example. VaR 99% is the value at risk for the confidence level 99% and VaR 95% is the value at risk for the confidence level 95%. The abbreviation s.d. is used for standard deviation.

FIG. 11 shows the loss distribution from Impact sub-model #2, i.e. losses due to insider theft or abuse. Theft includes maintenance and spares as well as information. Again, no tail events are evident.

Table 5 shows a statistical description of the loss distributions for theft with and without a redundant system. With a redundant system, there is more to steal in terms of spare parts and maintenance supplies. However the overall differences are small.

TABLE 5

| | single | double |
|---|---|---|
| mean | 15,759 | 23,709 |
| s.d. | 35,569 | 45,266 |
| 99% VaR | 164,998 | 206,222 |
| 95% VaR | 80,052 | 109,784 |
| min | 0 | 0 |
| max | 655,657 | 774,573 |

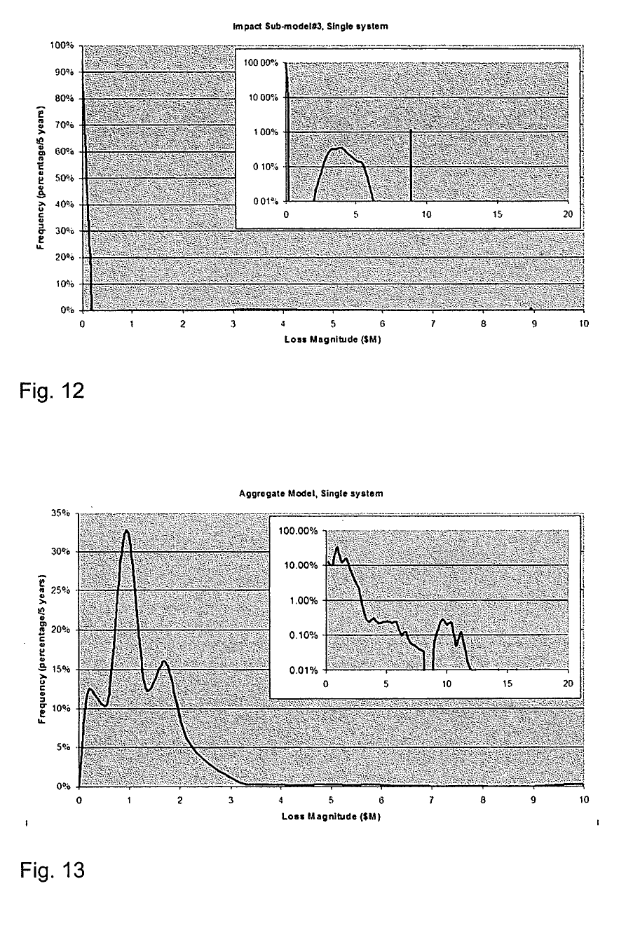

FIG. 12 shows the Impact sub-model #3, i.e. losses due to war and terrorist attacks. Here most of the events are in the tail and are due to both partial and total system losses.

Table 6 shows statistical description of the loss distributions due to war and terrorist attacks with and without a redundant system. The redundant system incurs a slightly higher risk, which is due to the fact that the worst-case scenario, i.e. total loss, is actually worse in the redundant system than in the non-redundant system because there are more assets to lose.

TABLE 6

| | single | double |
|---|---|---|
| mean | 182,959 | 204,331 |
| s.d. | 1,116,565 | 1,243,214 |
| 99% VaR | 8,994,178 | 9,428,824 |
| 95% VaR | 456 | 335 |
| min | 0 | 0 |
| max | 15,098,522 | 16,162,506 |

The independent loss distributions from the three impact sub-models can be aggregated into the total loss distribution using a numerical convolution program. FIG. 13 shows the total loss distribution resulting from aggregating the loss distributions of the three impact sub-models #1, #2 and #3 for a non-redundant system.

Now the value (in operational risk terms) of having a redundant system and the difference between different server-replacement policies is examined. The former examination is a system-architectural question, and the latter is an operational question.

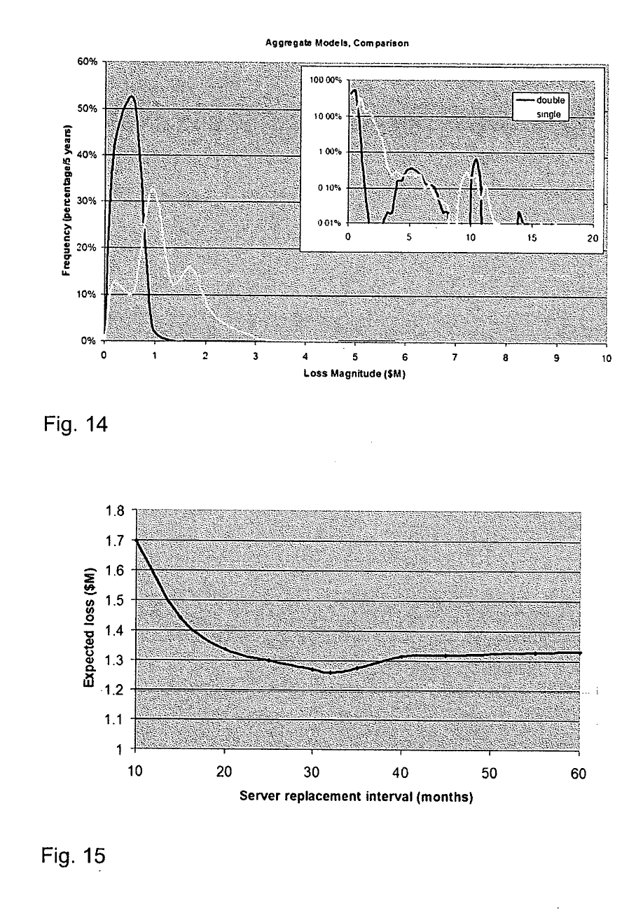

The total loss distributions in the two cases (with and without a redundant system) are compared in FIG. 14 and Table 7. It can be seen that although having a redundant system would reduce operational risk due to business disruption, it increases the operational risk due to insider stealing and war/terrorist attack, in addition to the extra cost of having a redundant system. For the decision on whether to have a redundant system, the decision maker should assess the risk preferences with respect to both mean and distributional aspects. In our example, although most indicators would clearly point to a preference for the redundant system, the single system might be preferable if the decision maker is only sensitive to the 99% VaR.

Table 7 shows the statistical description of the total impact distribution with and without redundant system.

TABLE 7

| | single | double |
|---|---|---|
| mean | 1,343,528 | 625,963 |
| s.d. | 1,292,178 | 1,256,480 |
| 99% VaR | 9,247,169 | 9,906,728 |
| 95% VaR | 2,740,314 | 819,350 |
| min | 40 | 326 |
| max | 19,499,075 | 18,500,173 |

The operational cost in the redundant system has a significantly lower mean than that in the single system. Regarding the business decision, especially for a large company, it can be derived that if the initial investment cost for having the redundant system is lower than the difference between the mean of the two cases (roughly $700,000 over the five-year period used), the company should go for the redundant system.

A non-redundant system and server replacement policies varying between 10 and 60 months are considered.

FIG. 15 gives the resulting expected total losses when implementing these various replacement intervals. The policy with a 32-month replacement interval yields the lowest total expected loss.

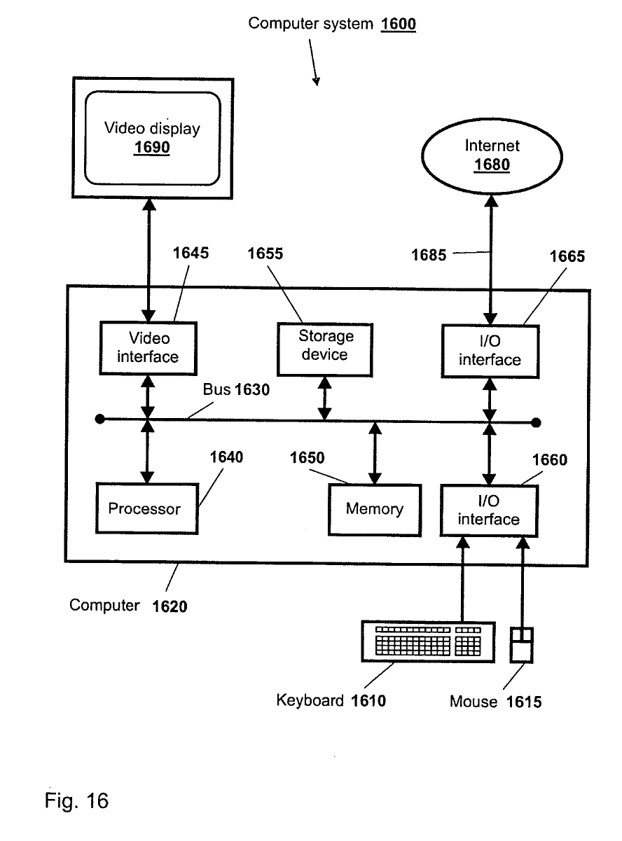

FIG. 16 is a schematic representation of a computer system 1600 that can be used to implement the techniques and methods described herein. Computer software executes under a suitable operating system installed on the computer system 1600 to assist in performing the described techniques. This computer software is programmed using any suitable computer programming language, and may be thought of as comprising various software code means for achieving particular steps.

The components of the computer system 1600 include a computer 1620, a keyboard 1610, a mouse 1615, and a video display 1690. The computer 1620 includes a processor 1640, a memory 1650, input/output (I/O) interfaces 1660, 1665, a video interface 1645, and a storage device 1655.

The processor 1640 is a central processing unit (CPU) that executes the operating system and the computer software executing under the operating system. The memory 1650 includes random access memory (RAM) and read-only memory (ROM), and is used under direction of the processor 1640.

The video interface 1645 is connected to video display 1690 and provides video signals for display on the video display 1690. User input to operate the computer 1620 is provided from the keyboard 1610 and mouse 1615. The storage device 1655 can include a disk drive or any other suitable storage medium.

Each of the components of the computer 1620 is connected to an internal bus 1630 that includes data, address, and control buses, to allow components of the computer 1620 to communicate with each other via the bus 1630.

The computer system 1600 can be connected to one or more other similar computers via the input/output (I/O) interface 1665 using a communication channel 1685 to a network, represented as the Internet 1680.

The computer software may be recorded on a portable storage medium, in which case, the computer software program is accessed by the computer system 1600 from the storage device 1655. Alternatively, the computer software can be accessed directly from the Internet 1680 by the computer 1620. In either case, a user can interact with the computer system 1600 using the keyboard 1610 and mouse 1615 to operate the programmed computer software executing on the computer 1620.

Other configurations or types of computer systems can be equally well used to implement the described methods and techniques. The computer system 1600 described above is described only as an example of a particular type of system suitable for implementing the described techniques and methods.

Various alterations and modifications can be made to the techniques and methods described herein, as would be apparent to one skilled in the relevant art.

By means of the presented methods operational risks can be reduced, managed, and controlled.

Any disclosed embodiment may be combined with one or several of the other embodiments shown and/or described. This is also possible for one or more features of the embodiments.

1. A method for modeling the operational risk of an entity, the method comprising the steps of:
Compiling a list with one or more failure events of the entity;
Compiling a list with one or more causes of the failure events;
Compiling a list with one or more impact types of the failure events;
Evaluating interdependencies between the failure events, the causes of the failure events and the impact types of the failure events;
Decomposing the interdependencies, thereby establishing one or more independent impact sub-models.

2. The method of claim 1, wherein the evaluation is performed by means of setting up an interdependency graph between the failure events, the causes of the failure events and the impact types of the failure events and wherein the independent impact sub-models are established by means of decomposing the interdependency graph.

3. The method of claim 1, wherein the impact sub-models comprise one or more failure sub-models that correspond to failure events which share the same causes.

4. The method of claim 1, wherein each of the impact sub-models comprises an impact-calculation sub-model that calculates from failure event arrivals the corresponding financial impacts for the entity.

5. The method of claim 3, further comprising the step of solving each failure sub-model separately.

6. The method of claim 1, wherein the impact sub-models are solved by means of statistical analysis.

7. The method of claim 1, wherein the impact sub-models are solved by means of simulation.

8. The method of claim 1, further comprising the step of combining the outputs of the impact sub-models to obtain the impact distribution of the entity.

9. The method of claim 8, wherein the impact distribution of the entity is derived from the impact sub-models by means of convolution.

10. The method of claim 8, wherein the impact distribution is represented in terms of losses.
